(19) United States
(12) Patent Application Publication
(10) Pub. No.: US 2014/0165082 A1
(43) Pub. Date: Jun. 12, 2014

(54) VIDEO PLAYBACK SYSTEM SUPPORTING GROUP-BASED BILLING MECHANISM AND RELATED COMPUTER PROGRAM PRODUCTS

(71) Applicant: GEMTEK TECHNOLOGY CO., LTD., Hsinchu (TW)

(72) Inventor: Hung-Wen CHEN, Hsinchu County (TW)

(73) Assignee: Gemtek Technology Co., Ltd., Hsinchu (TW)

(21) Appl. No.: 13/872,892

(22) Filed: Apr. 29, 2013

(30) Foreign Application Priority Data
Dec. 6, 2012 (TW) 101145821

(51) Int. Cl. H04N 21/2543; H04N 21/258

(52) U.S. Cl. CPC H04N 21/2543; H04N 21/25808
USPC 725/4; 725/110

(57) ABSTRACT

A video playback system includes a content provider server, first and second video decoders, a playback control server, and first and second mobile communication devices. The first and the second mobile communication devices belong to the same accessing group. The first mobile communication device transmits a first selection message to the playback control server to request the first video decoder to playback a target video provided by the content provider server. The second mobile communication device transmits a second selection message to the playback control server to request the second video decoder to playback the same target video. The content provider server performs a billing process on the basis of the accessing group, so that the first mobile communication device and the second mobile communication device would not be repeatedly charged for the target video.

### CROSS-REFERENCE TO RELATED APPLICATIONS

This application claims the benefit of priority to Patent Application No. 101145821, filed in Taiwan on Dec. 6, 2012; the entirety of which is incorporated herein by reference for all purposes.

### BACKGROUND

The disclosure generally relates to a video playback system and, more particularly, to a video playback system supporting a group-based billing mechanism and related computer program products.

With the progress of internet, many video playback systems for transmitting video contents through internet have been developed. In conventional applications, however, a content service provider only allots one remote control to each video decoder, such as a set-top box. Once the remote control is lost or damaged, the video decoder would be unable to be manipulated by the user.

Additionally, the content service provider typically performs identity authentication and billing process with respect to a user based on a single video decoder, such as a set-top box, binding with the user. If the user has installed multiple video decoders of the same content service provider, videos playbacked by different video decoders are separately charged even if those video decoders are utilized to playback the same video.

Furthermore, in existing structure of the video playback system, the content service provider can only perform the identity authentication and billing process on the basis of a video decoder, but unable to perform the billing process on the basis of an device group consisted of multiple video decoders. This results in a great bottleneck for the promotion and application flexibility of the video playback system.

### SUMMARY

An example embodiment of a video playback system supporting a group-based billing mechanism is disclosed, comprising: a content provider server, configured to operably provide video signals of a target video; a first video decoder, configured to operably communicate with the content provider server via internet; a second video decoder, configured to operably communicate with the content provider server via internet; a playback control server; a first mobile communication device, configured to operably transmit a first selection message to the playback control server via internet to request the playback control server to control the first video decoder to playback the target video; and a second mobile communication device, configured to operably transmit a second selection message to the playback control server via internet to request the playback control server to control the second video decoder to playback the target video, wherein the first mobile communication device and the second mobile communication device belong to a same accessing group; wherein the playback control server transmits a group identification data of the accessing group to the first video decoder and the second video decoder via internet, so that the first video decoder and the second video decoder request the content provider server to provide the video signals of the target video and transmit the group identification data to the content provider server for verification, and the content provider server performs a billing process on the basis of the accessing group to charge for the purchasing of the target video only on a billing record of the first mobile communication device, and not to charge for the purchasing of the target video on a billing record of the second mobile communication device.

An example embodiment of a computer program product is disclosed. The computer program product is stored in a non-transitory storage device of a playback control server. When the computer program product is executed by a processing circuit of the playback control server, the computer program product enables the playback control server to perform a video playback control operation. The video playback control operation comprises: receiving a first selection message requesting to control a first video decoder to playback a target video and transmitted from a first mobile communication device via internet; receiving a second selection message requesting to control a second video decoder to playback the target video and transmitted from a second mobile communication device via internet, wherein the first communication device and the second communication device belong to a same accessing group; transmitting a group identification data of the accessing group to the first video decoder via internet, so that the first video decoder requests the content provider server to provide video signals of the target video and transmits the group identification data to the content provider server for verification; and transmitting the group identification data to the second video decoder via internet, so that the second video decoder requests the content provider server to provide the video signals of the target video and transmits the group identification data to the content provider server for verification.

One of the advantages of the aforementioned example embodiments is that each of the mobile communication devices can be utilized as a basis of identity authentication of its user, and the billing process is performed on the basis of the accessing group formed by different mobile communication devices in order to support a group-based billing mechanism for videos. As a result, different video decoders corresponding to the same accessing group are allowed to playback the same video and would not be charged repeatedly.

Another advantage of the aforementioned embodiments is that the mobile communication device is allowed to manipulate a video decoder in a remote distance through the playback control server, thereby greatly expanding functionality, applicability, and flexibility of the video playback system.

Another example embodiment of a video playback system supporting a group-based billing mechanism is disclosed, comprising: a content provider server, configured to operably provide video signals of a target video; a first video decoder, configured to operably communicate with the content provider server via internet; a playback control server; a first mobile communication device, configured to operably transmit a first selection message to the playback control server via internet to request the playback control server to control the first video decoder to playback the target video; and a second mobile communication device, configured to operably transmit a third selection message to the playback control server via internet to request the playback control server to control the first video decoder to playback the target video, wherein the first mobile communication device and the second mobile communication device belong to a same accessing group; wherein the playback control server transmits a group identification data of the accessing group to the first video decoder via internet, so that the first video decoder requests the content provider server to provide the video signals of the target video and transmits the group identification data to the content provider server for verification, and the content provider server performs a billing process on the basis of the accessing group to charge for the purchasing of the target video only on a billing record of the first mobile communication device, and not to charge for the purchasing of the target video on a billing record of the second mobile communication device.

One of the advantages of the aforementioned embodiment is that different mobile communication devices are allowed to control the same video decoder through the playback control server, thereby effectively improving the convenience of manipulating the video decoder.

Another advantage of the aforementioned example embodiment is that each of the mobile communication devices can be utilized as a basis of identity authentication and billing process of its user to support a group-based billing mechanism for videos. This allows the users of different mobile communication devices corresponding to the same accessing group to playback the same video with the same video decoder and would not be charged repeatedly.

Another advantage of the aforementioned example embodiment is the mobile communication device can be utilized as a basis for identity authentication and billing procedures to support a video billing approach of group-based billing mechanism and allow different users corresponding to the same accessing group to utilize different mobile communication devices to play the same video through the same video decoder so as not to cause the users to be charged repeatedly.

Another advantage of the aforementioned embodiment is that the mobile communication device is allowed to manipulate a video decoder in a remote distance through the playback control server, thereby greatly expanding functionality, applicability, and flexibility of the video playback system.

Both the foregoing general description and the following detailed description are examples and explanatory only, and are not restrictive of the invention as claimed.

### BRIEF DESCRIPTION OF THE DRAWINGS

FIG. 1 shows a simplified functional block diagram of a video playback system with multiple video decoders according to one embodiment of the present disclosure.

FIGS. 2-3 show simplified flowcharts illustrating a video playback control method according to a first embodiment of the present disclosure.

FIG. 4 shows a simplified partial flowchart illustrating a video playback control method according to a second embodiment of the present disclosure.

### DETAILED DESCRIPTION

Reference is made in detail to embodiments of the invention, which are illustrated in the accompanying drawings. The same reference numbers may be used throughout the drawings to refer to the same or like parts, components, or operations.

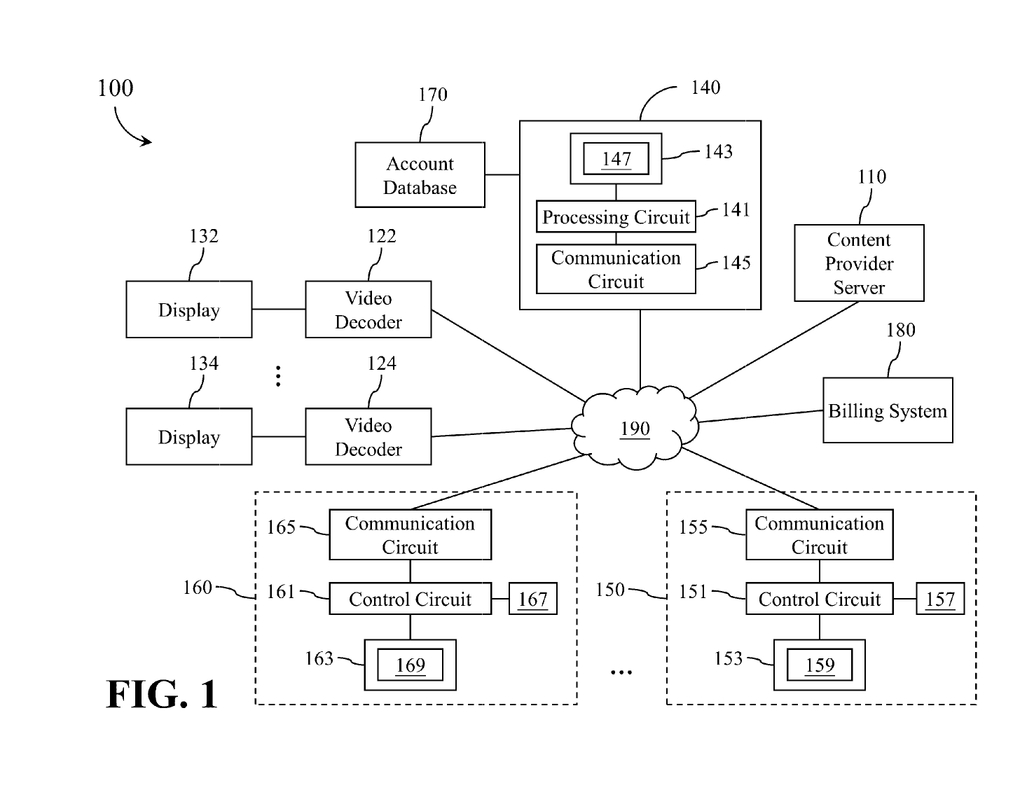

Please refer to FIG. 1, which shows a simplified functional block diagram of a video playback system 100 supporting a group-based billing mechanism according to one embodiment of the present disclosure. The video playback system 100 comprises a content provider server 110, multiple video decoders (e.g., the example video decoders 122 and 124 shown in FIG. 1), multiple displays (e.g., the example displays 132 and 134 shown in FIG. 1), a playback control server 140, multiple mobile communication devices (e.g., the example mobile communication devices 150 and 160 shown in FIG. 1), an account database 170, and a billing system 180. In this embodiment, the content provider server 110, the video decoders 122 and 124, the mobile communication devices 150 and 160, and the billing system 180 communicate with the playback control server 140 via the internet 190.

The content provider server 110 is configured to operably provide video signals of a target video. The video decoders 122 and 124 are configured to operably communicate with the content provider server 110 via the internet 190 to receive the video signals transmitted from the content provider server 110. The displays 132 and 134 are respectively coupled with the video decoders 122 and 124, and configured to operably display video content outputted from the video decoders 122 and 124. The playback control server 140 is configured to operably control the video decoders 122 and 124 via the internet 190. The mobile communication devices 150 and 160 are configured to operably transmit control messages to the playback control server 140 via the internet 190 to request to utilize the video decoder 122 and/or the video decoder 124 to playback the target video. In the video playback system 100, the mobile communication devices 150 and 160 belong to the same accessing group. The playback control server 140 is configured to operably to transmit a group identification data of the accessing group (e.g., a group ID of the accessing group) to the video decoder 122 and/or the video decoder 124 via the internet 190, so that the video decoder 122 and/or the video decoder 124 request the content provider server 110 to provide the video signals of the target video and transmit the group identification data to the content provider server 110 for verification. The content provider server 110 performs a billing process on the basis of the accessing group to charge for the purchasing of the target video only on a billing record of the mobile communication device 150, and not to charge for the purchasing of the target video on a billing record of the mobile communication device 160. As a result, the mobile communication device 150 and the mobile communication device 160 would not be repeatedly charged for the target video.

In the video playback system 100, each of the mobile communication devices 150 and 160 may act as a remote control of the video decoders 122 and 124, but the mobile communication devices 150 and 160 indirectly manipulate the video decoders 122 and 124 through the playback control server 140. Additionally, the video signal of the target video selected by the mobile communication device 150 or 160 is directly transmitted to the video decoders 122 and 124 from the content provider server 110 via the internet 190, and the playback control server 140 does not act as an intermediate device for the transmission of the video signals.

In practical applications, the video decoders 122 and 124 may be located in different spots (such as different rooms) of the same building, or respectively located in different buildings. The video decoders 122 and 124 may be respectively realized with two set-top boxes. Alternatively, the video decoders 122 and 124 may be respectively integrated into the display 132 and the display 134.

As shown in FIG. 1, the playback control server 140 comprises a processing circuit 141, a non-transitory storage device 143, and a communication circuit 145, wherein both the storage device 143 and the communication circuit 145 are coupled with the processing circuit 141. The storage device 143 is stored with a playback control module 147. In practice, the playback control module 147 may be realized with one or more application program modules, and the storage device 143 may be realized with a volatile memory or a nonvolatile memory. The processing circuit 141 may be realized with one or more processor units. The communication circuit 145 may be realized with a wired communication circuit, a wireless communication circuit, or a hybrid circuit integrated with the functionalities of the above two circuits. The playback control server 140 may be realized with multiple servers located in the same geographic region, or may be realized with multiple servers located in different geographic regions. For the purpose of explanatory convenience, other components and connections in the playback control server 140 are not shown in FIG. 1.

In the embodiment of FIG. 1, the mobile communication device 150 comprises a control circuit 151, a non-transitory storage device 153, a communication circuit 155, and an input device 157, wherein the storage device 153, the communication circuit 155, and the input device 157 are coupled with the control circuit 151. Similar to the mobile communication device 150, the mobile communication device 160 comprises a control circuit 161, a non-transitory storage device 163, a communication circuit 165, and an input device 167, wherein the storage device 163, the communication circuit 165, and the input device 167 are coupled with the control circuit 161. In practice, each of the control circuits 151 and 161 may be realized with one or more processor units. Each of the communication circuits 155 and 165 may be realized with a wired communication circuit, a wireless communication circuit, or a hybrid circuit integrated with the functionalities of the above two circuits. Each of the input devices 157 and 167 may be realized with a touch screen, a touch pad, a keyboard, a mouse, a voice control device, or various combinations of aforementioned devices. Additionally, the storage device 153 is stored with a video remote control module 159 realized with one or more application program modules, and the storage device 163 is stored with a video remote control module 169 realized with one or more application program modules.

In applications, each of the mobile communication devices 150 and 160 may be realized with any mobile electronic device having networking capability, such as a cell phone, a tablet computer, a notebook computer, a netbook computer, an E-book, or a handheld game console, or the like. For the purpose of explanatory convenience, other components and connections in each of the mobile communication devices 150 and 160 are not shown in FIG. 1.

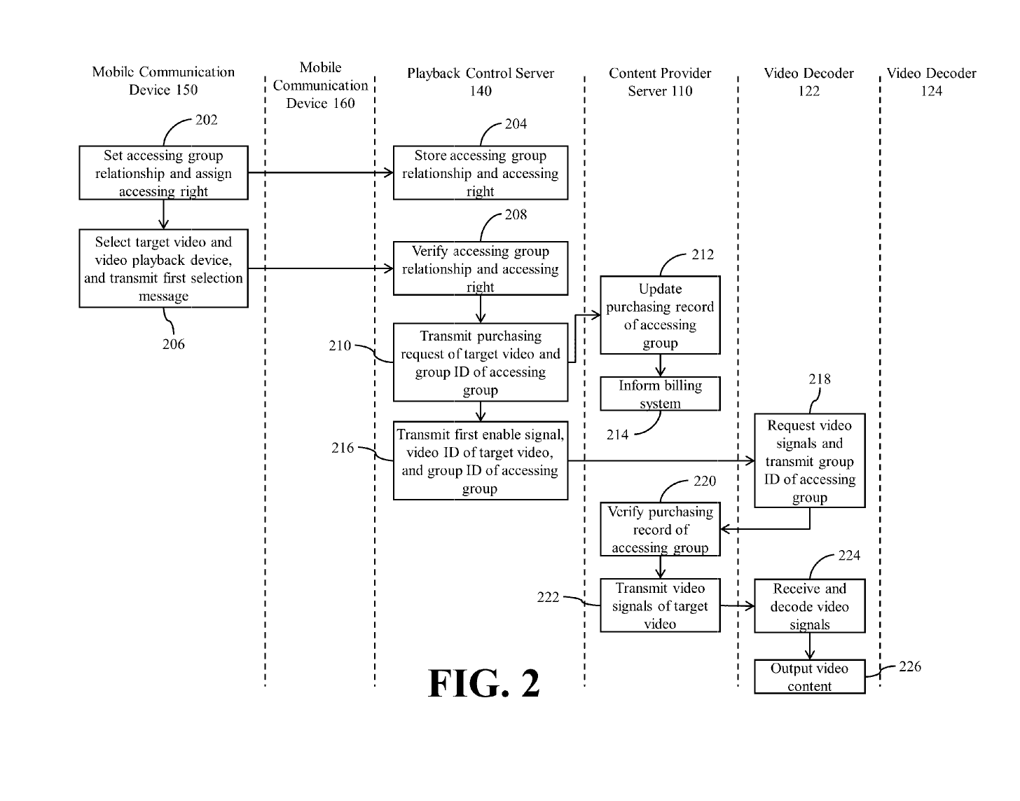

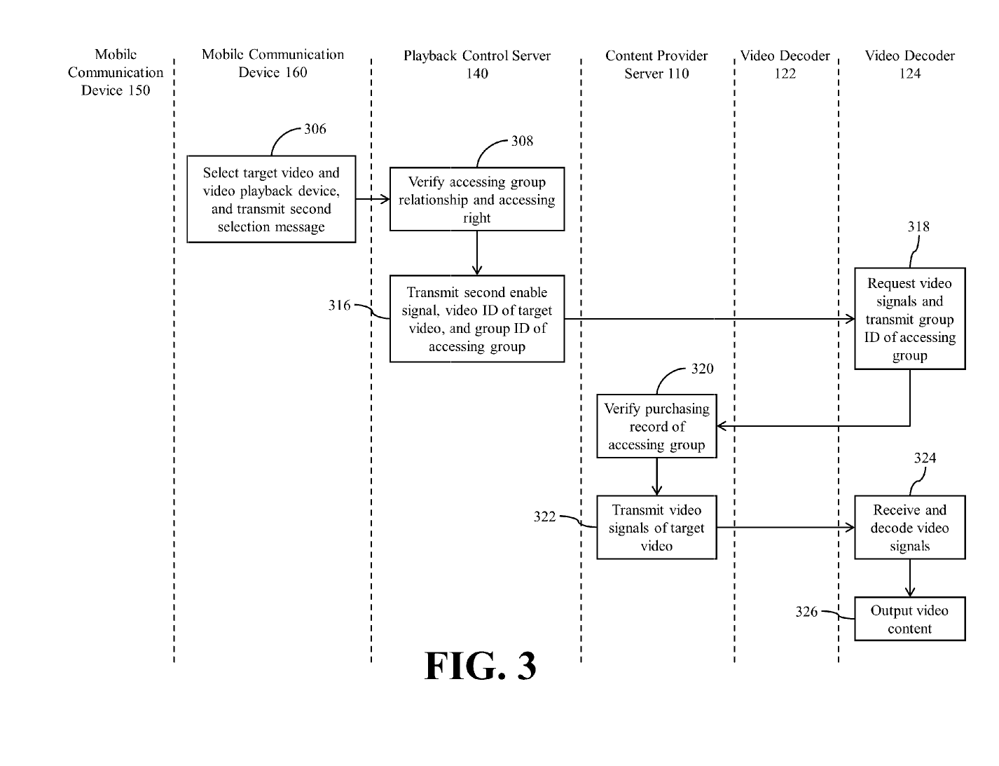

The operations of the video playback system 100 will be further described in the following by reference to FIG. 2 and FIG. 3.

FIGS. 2-3 collectively show a simplified flowchart illustrating a video playback control method adopted by the video playback system 100 according to a first embodiment of the present disclosure. In FIGS. 2-3, operations within a column under the name of a specific device are operations to be performed by the specific device. For example, in FIG. 2, operations within a column under the label “playback control server 140” are operations to be performed by the playback control server 140, operations within a column under the label “video decoder 122” are operations to be performed by the video decoder 122, and so forth. The same analogous arrangement also applies to the subsequent flowcharts.

When the user of the mobile communication device 150 wants to watch a video, the user may utilize the input device 157 of the mobile communication device 150 to instruct the control circuit 151 to execute the video remote control module 159, so as to enable the mobile communication device 150 to perform some or all operations in the corresponding column in FIG. 2 and FIG. 3. Similarly, when the user of the mobile communication device 160 wants to watch a video, the user may utilize the input device 167 of the mobile communication device 160 to instruct the control circuit 161 to execute the video remote control module 169, so as to enable the mobile communication device 160 to perform some or all operations in the corresponding column in FIG. 2 and FIG. 3. The processing circuit 141 of the playback control server 140 executes the playback control module 147 to enable the playback control server 140 to perform some or all operations in the corresponding column.

In the operation 202, the video remote control module 159 of the mobile communication device 150 may set an accessing group relationship indicating that the mobile communication devices 150 and 160 belong to a same accessing group AG1, and respectively assign different video accessing rights to the mobile communication devices 150 and 160. For example, the user of the mobile communication device 150 may be a parent of a family and the user of the mobile communication device 160 may be a child in the family. In this case, the video remote control module 159 may assign a higher video accessing right to the mobile communication device 150 and assign a more limit accessing right to the mobile communication device 160 according to the user manipulation to the mobile communication device 150. For example, the mobile communication device 160 may be restricted to be able to access only some kinds of video, or to be able to access videos only during some predetermined periods. Then, the video remote control module 159 may utilize the communication circuit 155 to transmit the accessing group relationship of the accessing group AG1 and related information of the accessing right to the playback control server 140 via the internet 190. In practice, the aforementioned accessing group relationship may comprise a matching information among the SIM numbers of the mobile communication devices 150 and 160 and a group ID of the accessing group.

When the settings of the accessing group relationship and the accessing right are received by the playback control server 140, the playback control server 140 performs the operation 204 to store the received settings of the accessing group relationship and the accessing right.

Afterward, when the user of the mobile communication device 150 wants to watch a video, the video remote control module 159 performs the operation 206 requests the user to utilize the input device 157 to select a target video to be playbacked and a video playback device. When completing the above selection, the video remote control module 159 utilizes the communication circuit 155 to transmit a first selection message containing the video ID or related identification data of the selected target video as well as the selected video playback device to the playback control server 140 through the internet 190. For the purpose of explanatory convenience in the following descriptions, it is assumed herein that the first selection message indicates that the video playback device is the video decoder 122.

In the operation 208, the playback control module 147 of the playback control server 140 utilizes the communication circuit 145 to receive the first selection message transmitted from the mobile communication device 150. In addition, the playback control module 147 verifies the group relationship corresponding to the mobile communication device 150 and also verifies the accessing right of the mobile communication device 150. In practice, the playback control server 140 may conduct an identity authentication procedure on the mobile communication device 150 in the operation 208. When performing the identity authentication procedure, the playback control server 140 may generate a related identity inquiring webpage to request the user of the mobile communication device 150 to input identification data (such as a cell phone number, a user alias, or a ID number) and a corresponding password. Then, the playback control server 140 may compare the identification data transmitted from the mobile communication device 150 with data stored in the account database 170. If the identification data transmitted from the mobile communication device 150 matches with the data stored in the account database 170, the playback control server 140 determines that the mobile communication device 150 passed the identity authentication procedure. Otherwise, the playback control server 140 returns a message indicating that the identity authentication is failed to the mobile communication device 150.

When the mobile communication device 150 passed the authentication procedure of the operation 208, the playback control module 147 performs the operation 210 to utilize the communication circuit 145 to transmit a purchasing request of the target video made by the accessing group AG1 to which the mobile communication device 150 belongs to the content provider server 110 through the internet 190. In the operation 210, the playback control module 147 also utilizes the communication circuit 145 to transmit the group identification data of the accessing group AG1 (e.g., a group ID of the accessing group AG1) to the content provider server 110 through the internet 190.

In the operation 212, the content provider server 110 updates the purchasing record of the accessing group according to the received purchasing request and the group identification data of the accessing group AG1.In practice, the content provider server 110 may utilize a storage device (not shown) to store the updated purchasing record of the accessing group. In this embodiment, the content provider server 110 performs the billing process on the basis of the accessing group AG1,not on the basis of the video decoder.

Accordingly, the content provider server 110 then performs the operation 214 to inform the billing system 180 of the updated purchasing record of the accessing group AG1, so that the billing system 180 charges for the purchasing of the target video on the billing record of the mobile communication device 150.

In this embodiment, the playback control module 147 opts to utilize the video decoder 122 to receive the video signals of the target video according to the first selection message. Accordingly, in the operation 216, the playback control module 147 utilizes the communication circuit 145 to transmit a first enable signal EN1, the video identification data of the target video (e.g., a video ID of the target video), and the group identification data of the accessing group AG1 to the video decoder 122 via the internet 190.

When the video decoder 122 received the first enable signal EN1, the identification data of the target video, and the group identification data of the accessing group AG1, the video decoder 122 performs the operation 218 to send a request to the content provider server 110 via the internet 190 to request the content provider server 110 to provide the video signals of the target video. In addition, the video decoder 122 transmits the group identification data of the accessing group AG1 to the content provider server 110 in the operation 218.

In the operation 220, the content provider server 110 verifies the purchasing record of the accessing group AG1 according to the received identification data of the accessing group AG1 to determine whether the video decoder 122 has the accessing right of the target video. For example, the content provider server 110 may inquire the storage device mentioned in the operation 212 about the purchasing record of the accessing group AG1 or may inquire the billing system 180 about the purchasing record of the accessing group AG1. If the accessing group AG1 has purchased the target video, then the content provider server 110 determines that the video decoder 122 has the accessing right of the target video.

Then, the content provider server 110 performs the operation 222 to transmit the video signals of the target video to the video decoder 122 via the internet 190.

In the operation 224, the video decoder 122 receives and decodes the video signals of the target video.

In the operation 226, the video decoder 122 outputs the decoded video content to the display 132 to playback the target video.

While the video decoder 122 and the display 132 playback the target video, or after playbacking the target video, if the user of the mobile communication device 160 wants to watch the same target video, the video remote control module 169 may be utilized to perform the operation 306 in FIG. 3.

In the operation 306, the video remote control module 169 requests the user to utilize the input device 167 to select the target video to be playbacked and a video playback device. When completing the above selection, the video remote control module 169 utilizes the communication circuit 165 to transmit a second selection message containing the video ID or related identification data of the selected target video as well as the selected video playback device to the playback control server 140 through the internet 190. For the purpose of explanatory convenience in the following descriptions, it is assumed herein that the second selection message indicates that the video playback device is the video decoder 124.

In the operation 308, the playback control module 147 of the playback control server 140 utilizes the communication circuit 145 to receive the second selection message transmitted from the mobile communication device 160. In addition, the playback control module 147 verifies the group relationship corresponding to the mobile communication device 160 and also verifies the accessing right of the mobile communication device 160. In this embodiment, the playback control module 147 may obtain that the mobile communication device 160 and the mobile communication device 150 both belong to the accessing group AG1 according to the accessing group relationship stored in the aforementioned operation 204. In practice, the playback control server 140 may conduct an identity authentication procedure on the mobile communication device 160 in the operation 308. When performing the identity authentication procedure, the playback control server 140 may generate a related identity inquiring webpage to request the user of the mobile communication device 160 to input identification data (such as a cell phone number, a user alias, or a ID number) and a corresponding password. Then, the playback control server 140 may compare the identification data transmitted from the mobile communication device 160 with data stored in the account database 170. If the identification data transmitted from the mobile communication device 160 matches with the data stored in the account database 170, the playback control server 140 determines that the mobile communication device 160 passed the identity authentication procedure. Otherwise, the playback control server 140 returns a message indicating that the identity authentication is failed to the mobile communication device 160.

When the mobile communication device 160 passed the authentication procedure of the operation 308, the playback control module 147 performs the operation 316.

In this embodiment, the playback control module 147 opts to utilize the video decoder 124 to receive the video signals of the tat video according to the received second selection message. Accordingly, in the operation 316, the playback control module 147 utilizes the communication circuit 145 to transmit a second enable signal EN2, the identification data of the target video, and the group identification data of the accessing group AG1 to the video decoder 124 via the internet 190.

When the video decoder 124 received the second enable signal EN2, the identification data of the target video, and the group identification data of the accessing group AG1, the video decoder 124 performs the operation 318 to send a request to the content provider server 110 via the internet 190 to request the content provider server 110 to provide the video signals of the target video. In addition, the video decoder 124 transmits the group identification data of the accessing group AG1 to the content provider server 110 in the operation 318.

In the operation 320, the content provider server 110 verifies the purchasing record of the accessing group AG1 according to the received identification data of the accessing group AG1 to determine whether the video decoder 124 has the accessing right of the target video. Similarly, the content provider server 110 may inquire the storage device mentioned in the operation 212 about the purchasing record of the accessing group AG1 or may inquire the billing system 180 about the purchasing record of the accessing group AG1. In this embodiment, since the accessing group AG1 has purchased the target video, the content provider server 110 determines that the video decoder 124 has the accessing right of the target video. As described previously, the content provider server 110 of this embodiment performs the billing process on the basis of the accessing group AG1, not on the basis of the video decoder. Accordingly, the content provider server 110 does not treat the playback request of the target video made by the video decoder 124 as another chargeable purchase, so that the billing system 180 would not charge for the purchasing of the target video on the billing record of the mobile communication device 160.

Then, the content provider server 110 performs the operation 322 to transmit the video signals of the target video to the video decoder 124 via the internet 190.

In the operation 324, the video decoder 124 receives and decodes the video signals of the target video.

In the operation 326, the video decoder 124 outputs the decoded video content to the display 134 to playback the target video.

It can be appreciated from the foregoing descriptions that different mobile communication devices 150 and 160 in the video playback system 100 are allowed to indirectly control the video decoders 122 and 124 through the playback control server 140. In addition, since the mobile communication devices 150 and 160 are set as the same accessing group in advance, the playback of the same target video made by the video decoders 122 and 124 under the control of the mobile communication devices 150 and 160 would not be charged twice. Such billing mechanism greatly increases the application flexibility of the video playback system 100.

Additionally, the mobile communication devices 150 and 160 communicate with the playback control server 140 via the internet 190, and the playback control server 140 communicates with the video decoders 122 and 124 via the internet 190. Accordingly, the users of the mobile communication devices 150 and 160 are enabled to manipulate the video decoders 122 and 124 even if the mobile communication devices 150 and 160 are located far away from the video decoders 122 and 124. As a result, the applications and the operational flexibility of the video playback system 100 can be effectively increased.

In another embodiment, the playback control module 147 in the aforementioned operation 308 may further check whether the second selection message is received within a predetermined period (e.g., 48 or 72 hours) since the target video is purchased by the accessing group AG1. The playback control module 147 may assign the accessing right of the target video to the mobile communication device 160 and perform the subsequent operations only if the second selection message is received within a predetermined period since the target video is purchased by the accessing group AG1.

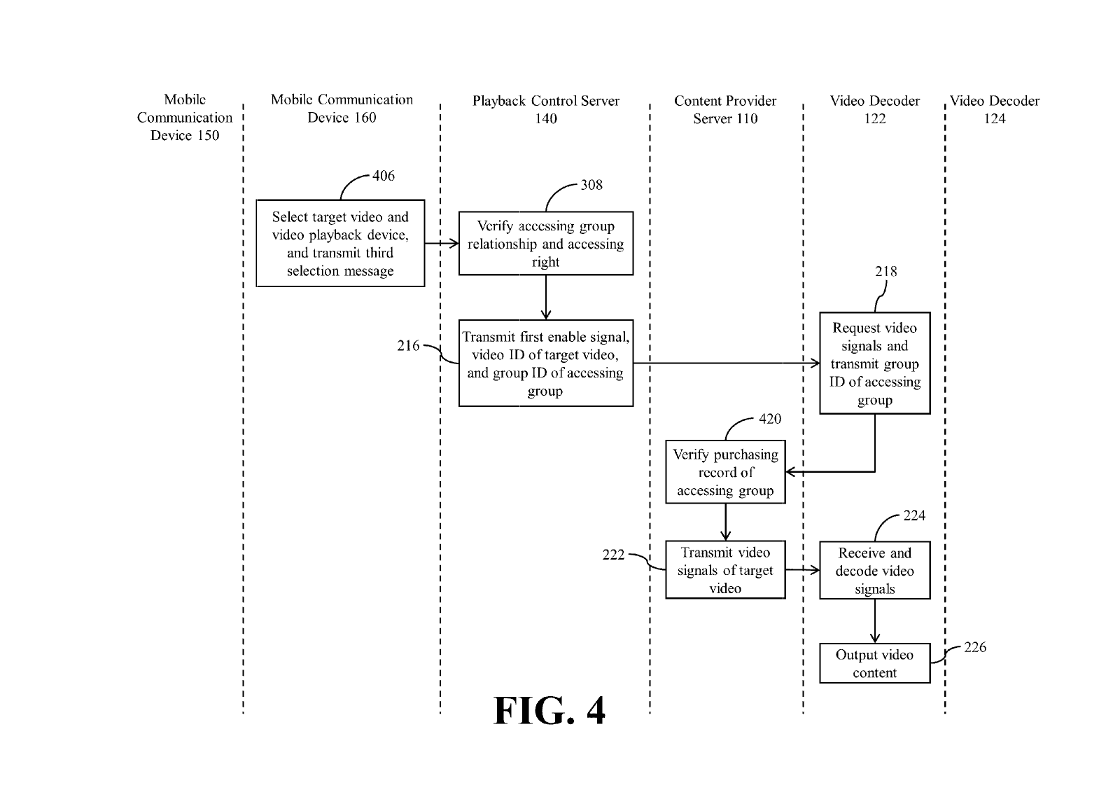

In the foregoing embodiment illustrated in FIG. 2 and FIG. 3, the mobile communication devices 150 and 160 of the video playback system 100 are allowed to control the video decoders 122 and 124 to playback the same target video and would not be charged for the target video repeatedly. In other embodiments, the mobile communication devices 150 and 160 of the video playback system 100 are also allowed to control the same video decoder to playback the same target video and would not be charged for the target video repeatedly. For example, FIG. 4 shows a simplified partial flowchart illustrating a video playback control method adopted by the video playback system 100 according to a second embodiment of the present disclosure.

After completing the operations of FIG. 2 (i.e., after the video decoder 122 finished playbacking the target video), if the user of the mobile communication device 160 wants to utilize the same video decoder 122 to playback the same target video, the video remote control module 169 may be utilized to perform the operation 406 in FIG. 4.

In the operation 406, the video remote control module 169 requests the user to utilize the input device 167 to select the target video to be playbacked and a video playback device. When completing the above selection, the video remote control module 169 utilizes the communication circuit 165 to transmit a third selection message containing the video ID or related identification data of the selected target video as well as the selected video playback device to the playback control server 140 through the internet 190. In this embodiment, the third selection message indicates that the video playback device is the video decoder 122.

Then, the playback control module 147 of the playback control server 140 performs the operation 308 to utilize the communication circuit 145 to receive the third selection message transmitted from the mobile communication device 160. In addition, the playback control module 147 verifies the group relationship corresponding to the mobile communication device 160 and also verifies the accessing right of the mobile communication device 160. In this embodiment, the playback control module 147 may obtain that the mobile communication device 160 and the mobile communication device 150 both belong to the accessing group AG1according to the accessing group relationship stored in the aforementioned operation 204.

Since the third selection message received by the playback control module 147 instructs the playback control server 140 to opt to utilize the video decoder 122 to receive the video signals of the target video, when the mobile communication device 160 passed the authentication procedure of the operation 308, the playback control module 147 performs the operation 216 of FIG. 2 to utilize the communication circuit 145 to transmit the first enable signal EN1, the identification data of the target video, and the group identification data of the accessing group AG1 to the video decoder 122 via the internet 190.

When the video decoder 122 received the first enable signal EN1, the identification data of the target video, and the group identification data of the accessing group AG1, the video decoder 122 performs the aforementioned operation 218 to send a request to the content provider server 110 via the internet 190 to request the content provider server 110 to provide the video signals of the target video. In addition, the video decoder 122 transmits the group identification data of the accessing group AG1 to the content provider server 110 in the operation 218.

In the operation 420, the content provider server 110 verifies the purchasing record of the accessing group AG1 according to the received identification data of the accessing group AG1 to determine whether the video decoder 122 has the accessing right of the target video. Similarly, the content provider server 110 may inquire the storage device mentioned in the operation 212 about the purchasing record of the accessing group AG1 or may inquire the billing system 180 about the purchasing record of the accessing group AG1. In this embodiment, since the accessing group AG1 has purchased the target video, the content provider server 110 determines that the video decoder 122 has the accessing right of the target video. As described previously, the content provider server 110 of this embodiment performs the billing process on the basis of the accessing group AG1, not on the basis of the video decoder. Accordingly, the content provider server 110 does not treat the playback request of the target video made by the video decoder 122 as another chargeable purchase, so that the billing system 180 would not charge for the purchasing of the target video on the billing record of the mobile communication device 160.

Then, the content provider server 110 performs the operation 222 to transmit the video signals of the target video to the video decoder 122 via the internet 190.

In the operation 224, the video decoder 122 receives and decodes the video signals of the target video.

In the operation 226, the video decoder 122 outputs the decoded video content to the display 132 to playback the target video.

Similar to the previous embodiment, the playback control module 147 in the operation 308 of FIG. 4 may further check whether the third selection message is received within a predetermined period since the target video is purchased by the accessing group AG1 to determine whether to assign the accessing right of the target video to the mobile communication device 160 and perform the subsequent operations.

In other words, the embodiment of FIG. 4 utilizes the operations 406 and 420 to replace the operations 306 and 320 of FIG. 3, and other operations in FIG. 4 are the same as those corresponding operations in FIG. 2. Accordingly, the aforementioned implementations and advantages of the other operations of FIG. 2 are also applicable to the embodiment of FIG. 4.

It can be appreciated from the foregoing descriptions that different mobile communication devices 150 and 160 are allowed to indirectly control the same video decoder 122 through the playback control server 140 by adopting the method illustrated in FIG. 2 and FIG. 4. In addition, since the mobile communication devices 150 and 160 are set as the same accessing group in advance, the playback of the same target video made by the video decoder 122 under the control of the mobile communication devices 150 and 160 would not be charged twice. As a result, the application flexibility of the video playback system 100 can be greatly increased.

In addition, the embodiment illustrated in FIG. 2 and FIG. 4 enables the same video decoder 122 to be controlled by different mobile communication devices 150 and 160. Accordingly, the video decoder 122 can still be manipulated even if its remote control is lost or damaged.

Furthermore, as described previously, the users of the mobile communication devices 150 and 160 are enabled to manipulate the video decoder 122 even if the mobile communication devices 150 and 160 are located far away from the video decoder 122. Accordingly, the users of the mobile communication devices 150 and 160 not only allowed to utilize the mobile communication devices 150 and 160 to control the video decoder 122 to playback a video of interest to be watched, but also allowed to remote control the video decoder 122 to playback a selected video to others, such as their family or friends in a remote distance, thereby greatly extending the functionalities and applications of the video playback system 100.

Certain terms are used throughout the description and the claims to refer to particular components. One skilled in the art appreciates that a component may be referred to as different names. This disclosure does not intend to distinguish between components that differ in name but not in function. In the description and in the claims, the term “comprise” is used in an open-ended fashion, and thus should be interpreted to mean “include, but not limited to.” The phrases “be coupled with,” “couples with,” and “coupling with” are intended to compass any indirect or direct connection. Accordingly, if this disclosure mentioned that a first device is coupled with a second device, it means that the first device may be directly or indirectly connected to the second device through electrical connections, wireless communications, optical communications, or other signal connections with/without other intermediate devices or connection means.

The term “and/or” may comprise any and all combinations of one or more of the associated listed items. In addition, the singular forms “a,” “an,” and “the” herein are intended to comprise the plural forms as well, unless the context clearly indicates otherwise.

Other embodiments of the invention will be apparent to those skilled in the art from consideration of the specification and practice of the invention disclosed herein. It is intended that the specification and examples be considered as exemplary only, with a true scope and spirit of the invention indicated by the following claims.

What is claimed is:

1. A video playback system supporting a group-based billing mechanism, comprising:
a content provider server, configured to operably provide video signals of a target video;
a first video decoder, configured to operably communicate with the content provider server via internet;
a second video decoder, configured to operably communicate with the content provider server via internet;
a playback control server;
a first mobile communication device, configured to operably transmit a first selection message to the playback control server via internet to request the playback control server to control the first video decoder to playback the target video; and
a second mobile communication device, configured to operably transmit a second selection message to the playback control server via internet to request the playback control server to control the second video decoder to playback the target video, wherein the first mobile communication device and the second mobile communication device belong to a same accessing group;
wherein the playback control server transmits a group identification data of the accessing group to the first video decoder and the second video decoder via internet, so that the first video decoder and the second video decoder request the content provider server to provide the video signals of the target video and transmit the group identification data to the content provider server for verification, and the content provider server performs a billing process on the basis of the accessing group to charge for the purchasing of the target video only on a billing record of the first mobile communication device, and not to charge for the purchasing of the target video on a billing record of the second mobile communication device.

2. The video playback system of claim 1, further comprising:
a first display, coupled with the first video decoder and configured to operably display video content outputted from the first video decoder; and
a second display, coupled with the second video decoder and configured to operably display video content outputted from the second video decoder.

3. The video playback system of claim 1, wherein the first communication device sets an accessing group relationship indicating that the first communication device and the second communication device belong to the same accessing group, and transmits the accessing group relationship to the playback control server via internet, and the playback control server stores the accessing group relationship.

4. The video playback system of claim 3, wherein the playback control server transmits the group identification data to the content provider server via internet after received the first selection message.

5. The video playback system of claim 4, wherein the playback control server further transmits a first enable signal and an identification data of the target video to the first video decoder after received the first selection message, and after the identification data of the target video is received by the first video decoder, the first video decoder requests the content provider server to provide the video signals of the target video and transmits the group identification data to the content provider server.

6. The video playback system of claim 5, wherein the playback control server further transmits a second enable signal and the identification data of the target video to the second video decoder after received the second selection message, and after the identification data of the target video is received by the second video decoder, the second video decoder requests the content provider server to provide the video signals of the target video and transmits the group identification data to the content provider server.

7. The video playback system of claim 6, wherein the playback control server verifies whether the second communication device belongs to the accessing group when received the second selection message, and the playback control server transmits the group identification data to the second video decoder via internet if the second communication device belongs to the accessing group.

8. A computer program product, stored in a non-transitory storage device of a playback control server, when executed by a processing circuit of the playback control server, enabling the playback control server to perform a video playback control operation, the video playback control operation comprising:
receiving a first selection message requesting to control a first video decoder to playback a target video and transmitted from a first mobile communication device via internet;
receiving a second selection message requesting to control a second video decoder to playback the target video and transmitted from a second mobile communication device via internet, wherein the first communication device and the second communication device belong to a same accessing group;
transmitting a group identification data of the accessing group to the first video decoder via internet, so that the first video decoder requests the content provider server to provide video signals of the target video and transmits the group identification data to the content provider server for verification; and
transmitting the group identification data to the second video decoder via internet, so that the second video decoder requests the content provider server to provide the video signals of the target video and transmits the group identification data to the content provider server for verification.

9. The computer program product of claim 8, wherein the video playback control operation further comprises:
receiving information of an accessing group relationship transmitted from the first communication device via internet, wherein the accessing group relationship indicates that the first communication device and the second communication device belong to the same accessing group; and
storing the accessing group relationship.

10. The computer program product of claim 9, wherein the video playback control operation further comprises:
transmitting the group identification data to the content provider server via internet after received the first selection message.

11. The computer program product of claim 10, wherein the video playback control operation further comprises:
transmitting a first enable signal and an identification data of the target video to the first video decoder after received the first selection message

12. The computer program product of claim 11, wherein the video playback control operation further comprises:
transmitting a second enable signal and the identification data of the target video to the second video decoder after received the second selection message.

13. The computer program product of claim 12, wherein the video playback control operation further comprises:
verifying whether the second communication device belongs to the accessing group when received the second selection message; and
transmitting the group identification data to the second video decoder via internet if the second communication device belongs to the accessing group.

14. A video playback system supporting a group-based billing mechanism, comprising:
a content provider server, configured to operably provide video signals of a target video;
a first video decoder, configured to operably communicate with the content provider server via internet;
a playback control server;
a first mobile communication device, configured to operably transmit a first selection message to the playback control server via internet to request the playback control server to control the first video decoder to playback the target video; and
a second mobile communication device, configured to operably transmit a third selection message to the playback control server via internet to request the playback control server to control the first video decoder to playback the target video, wherein the first mobile communication device and the second mobile communication device belong to a same accessing group;
wherein the playback control server transmits a group identification data of the accessing group to the first video decoder via internet, so that the first video decoder requests the content provider server to provide the video signals of the target video and transmits the group identification data to the content provider server for verification, and the content provider server performs a billing process on the basis of the accessing group to charge for the purchasing of the target video only on a billing record of the first mobile communication device, and not to charge for the purchasing of the target video on a billing record of the second mobile communication device.

15. The video playback system of claim 14, further comprising:
a first display, coupled with the first video decoder and configured to operably display video content outputted from the first video decoder.

16. The video playback system of claim 14, wherein the first communication device sets an accessing group relationship indicating that the first communication device and the second communication device belong to the same accessing group, and transmits the accessing group relationship to the playback control server via internet, and the playback control server stores the accessing group relationship.

17. The video playback system of claim 16, wherein the playback control server transmits the group identification data to the content provider server via internet after received the first selection message.

18. The video playback system of claim 17, wherein the playback control server further transmits an identification data of the target video to the first video decoder after received the first selection message or the third selection message, and after the identification data of the target video is received by the first video decoder, the first video decoder requests the content provider server to provide the video signals of the target video and transmits the group identification data to the content provider server.

19. The video playback system of claim 18, wherein the playback control server verifies whether the second communication device belongs to the accessing group when received the third selection message, and the playback control server transmits the group identification data to the second video decoder via internet if the second communication device belongs to the accessing group.
